(19) United States
(12) Patent Application Publication
(10) Pub. No.: US 2012/0204350 A1
(43) Pub. Date: Aug. 16, 2012

(54) INFLATABLE FOAM PILLOW AND METHODS OF MAKING AND USING THE SAME

(75) Inventor: Boris Katsnelson, Port Monmouth, NJ (US)

(73) Assignee: SLEEP INNOVATIONS, INC., West Long Branch, NJ (US)

(21) Appl. No.: 13/370,779

(22) Filed: Feb. 10, 2012

Related U.S. Application Data
(60) Provisional application No. 61/441,519, filed on Feb. 10, 2011.

(51) Int. Cl. A47G 9/10; B32B 37/06; B23P 11/00; B32B 37/12

(52) U.S. Cl. 5/644; 156/60; 156/73.1; 156/272.8; 156/308.2; 156/272.2; 112/475.01; 29/428

(57) ABSTRACT

The present disclosure provides for an inflatable foam pillow having a support layer. More particularly, the present disclosure provides for an inflatable foam pillow comprising a support layer, a shell, and a housing layer attached to the shell which surrounds the support layer and secures the support layer against a side wall of the shell. In some embodiments, the shell may be an inflatable bladder. In some embodiments, the pillow may further include a valve or pump for inflating, holding or releasing the air from the pillow.

### CROSS-REFERENCE TO RELATED APPLICATIONS

This application claims the benefit of and priority from U.S. Patent Application No. 61/441,519 filed Feb. 10, 2011, the contents of which is incorporated by reference herein in its entirety.

### SUMMARY

Embodiments herein relate generally to an inflatable foam pillow and methods of making and using such inflatable foam pillows.

Embodiments include an inflatable foam pillow comprising a housing layer, a shell that is attached to the housing layer, and a support layer secured between the housing layer and the shell. In some embodiments, the pillow can be inflated by inflating the shell. In some embodiments, the housing layer may be a mesh material. In some embodiments, the housing layer may be made from a material selected from nylon, polyester, polypropylene, polyethylene, polyvinyl chloride (PVC), polytetrafluoroethylene (PTFE), cotton, vinyl, wool, flax, jute, silk, acrylic, spandex, aramid, olefin, or the like and combinations thereof. In one embodiment, the support layer may comprise polyurethane foam. In other embodiments, the support layer may comprise viscoelastic polyurethane foam. In another embodiment, the support layer may comprise memory foam. In some embodiments, the shell may be an inflatable bladder. In some embodiments, the shell may comprise a plastic. In some embodiments, the shell may comprise a fabric. In some embodiments, the shell may comprise a rubber. In some embodiments, the shell may be selected from thermoplastic polyurethane, polyethylene, polystyrene, PVC, PTFE or the like and combinations thereof. In some embodiments, the pillow may further comprise a valve or pump for inflating, holding air in, or deflating the pillow.

Some embodiments include a method of making an inflatable foam pillow comprising covering a side of a support layer with a housing layer; and attaching a shell to the housing layer of the pillow so that the support layer is secured between the housing layer and the shell. Some embodiments include a method of making an inflatable foam pillow comprising adhering a support layer to a housing layer; and attaching a shell to the housing layer of the pillow so that the support layer is secured between the housing layer and the shell. In some embodiments, attaching may comprise attaching an edge of the housing layer to an edge of the shell. In some embodiments, attaching may include adhering the housing layer and the shell. In some embodiments, attaching may comprise sewing, gluing, heat sealing, laser welding, radio frequency welding, ultrasonic welding, adhesive sealing, stamping, chemical bonding or other suitable means. In some embodiments, attaching may comprise heat sealing the housing layer and the shell. In some embodiments, attaching may comprise bonding an edge of the housing layer and an edge of the shell. In some embodiments, attaching may comprise bonding the housing layer and the shell using a fastener. In some embodiments, the fastener may be buttons, zippers, clasps, loops, hooks, or a strip of hook material adapted to engage a loop pile material or a strip of loop material adapted to engage a hook material. In some embodiments, the fastener may be attached by sewing, gluing, heat sealing, adhesive sealing, ultrasonic welding, radio frequency welding, laser welding, stamping, chemical bonding or other suitable means.

### BRIEF DESCRIPTION OF THE DRAWINGS

FIG. 1 illustrates a sectional view of an inflatable foam pillow depicting a housing layer, comprising a mesh fabric, which covers a side of a support layer in accordance with an embodiment of the present disclosure. In this embodiment, the edges of the housing layer are bonded to the edges of a shell.

FIG. 2 illustrates a top view of the inflatable foam pillow, in accordance with an embodiment of the present disclosure.

FIG. 3 illustrates a bottom view of the inflatable foam pillow, in accordance with an embodiment of the present disclosure.

FIG. 4 illustrates a perspective view of an inflatable pillow, in accordance with an embodiment of the present disclosure.

FIG. 5 illustrates an inflatable pillow and a pillow sleeve, in accordance with embodiments of the present disclosure.

FIG. 6 illustrates a perspective view of an inflatable pillow, in accordance with an embodiment of the present disclosure.

### DETAILED DESCRIPTION

This invention is not limited to the particular processes, compositions, or methodologies described, as these may vary. The terminology used in the description is for the purpose of describing the particular versions or embodiments only, and it is not intended to limit the scope of the present invention which will be limited only by the appended claims. Unless defined otherwise, all technical and scientific terms used herein have the same meanings as commonly understood by one of ordinary skill in the art. All publications mentioned herein are incorporated by reference in their entirety. Nothing herein is to be construed as an admission that the invention is not entitled to antedate such disclosure by virtue of prior invention.

As used in this document, the singular forms “a”, “an”, and “the” include plural reference unless the context clearly dictates otherwise. Thus, for example, reference to a “foam” is a reference to one or more foams and equivalents thereof known to those skilled in the art, and so forth.

As used in this document, the term “about” means plus or minus 10% of the numerical value of the number with which it is being used. Therefore, about 50% means in the range of 45% to 55%.

As used in this document, the term “comprises” or “comprising” means “includes at least the following but does not exclude others.”

As used in this document, the term “fastener” includes, without limitation, buttons, zippers, clasps, loops, hooks, or a strip of hook material adapted to engage a loop pile material or a strip of loop pile material adapted to engage a hook material (a fastener of this type is typically known commercially as either VELFOAM™ or VELCRO™ but it can be known under other brand names as well). The fastener may be attached by sewing, gluing, heat sealing, ultrasonic welding, adhesive welding, radio frequency welding, laser welding, stamping, chemical bonding or other suitable means.

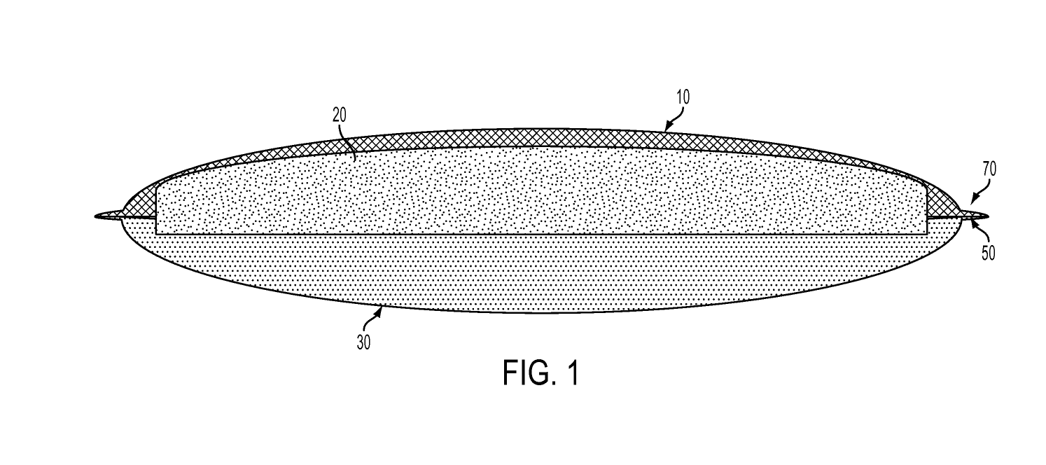

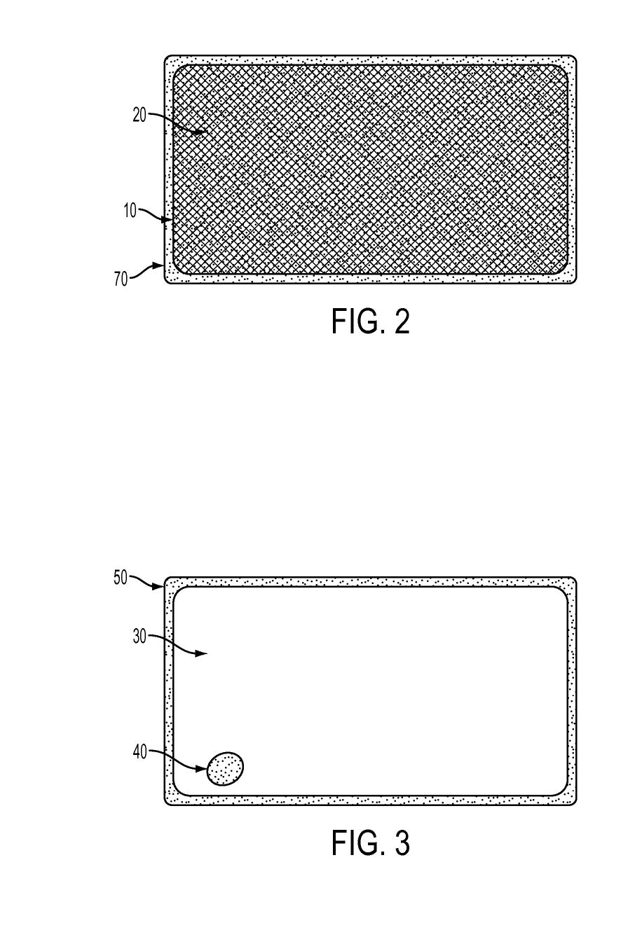

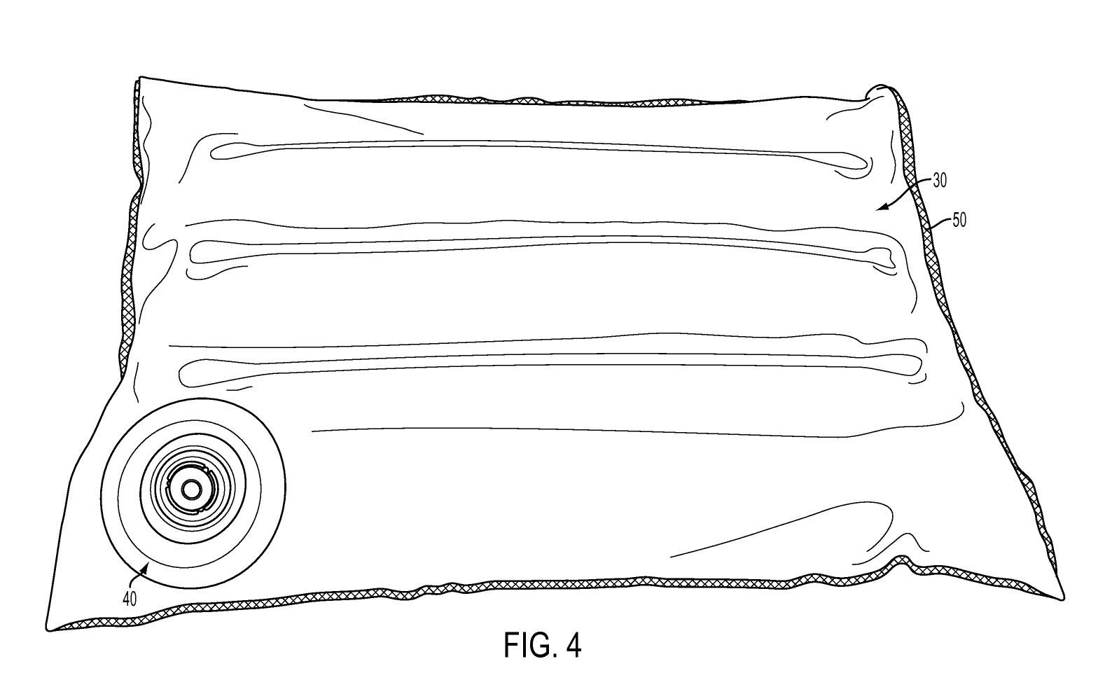

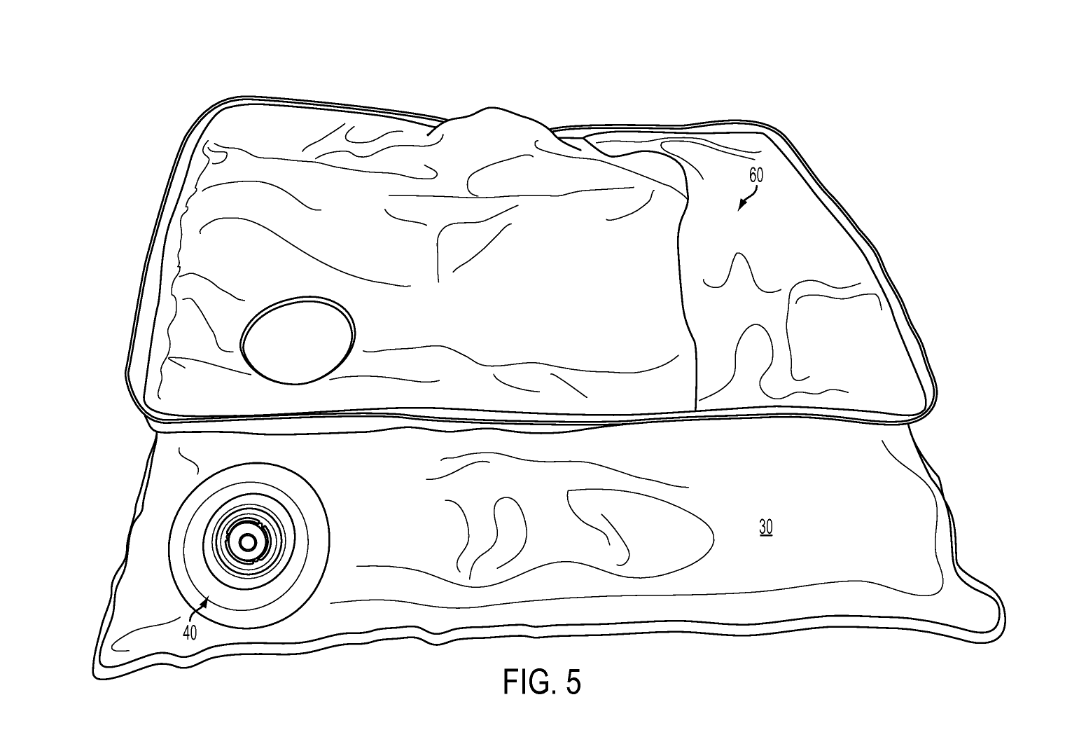

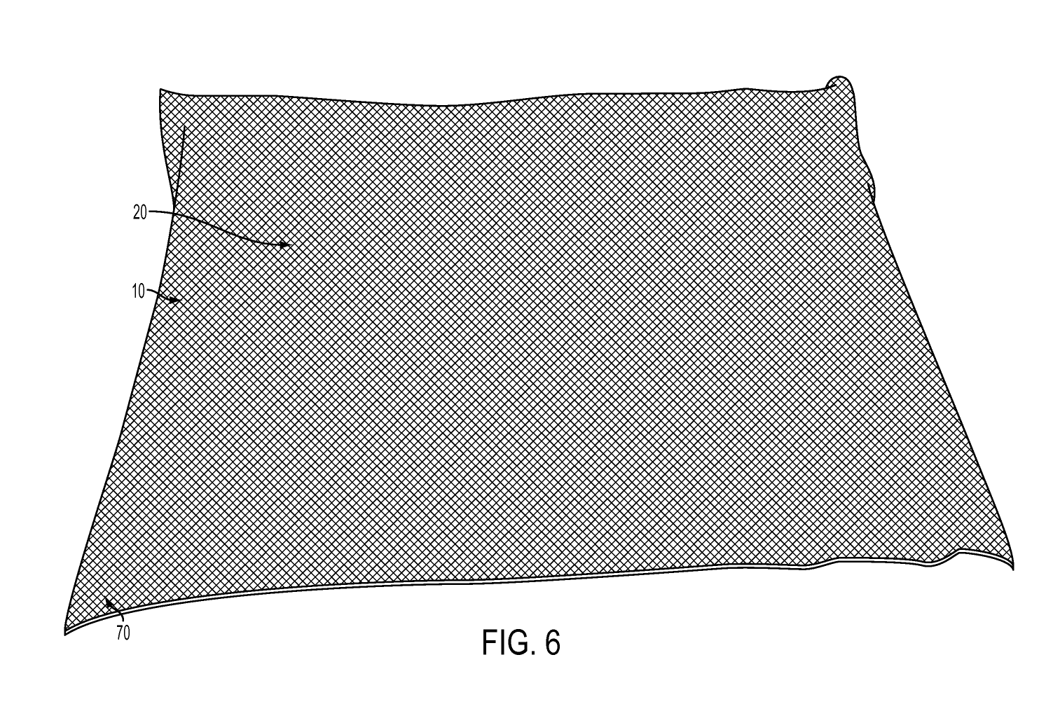

Referring to FIGS. 1-3, embodiments include an inflatable foam pillow comprising a support layer 20, a housing layer 10. The housing layer 10 may be bonded to a shell 30. The shell 30 may be expandable and, in some embodiments, the shell 30 may contain a void. The pillow may be inflated by inflating the shell 30. In some embodiments, the housing edge 70 of the housing layer 10 is bonded to the shell edge 50 of the shell 30. In some embodiments, the support layer 20 is placed between the housing layer 10 and a side wall of the shell 30. In some embodiments, the housing layer 10 surrounds a side of the support layer 20 and forms a pocket that secures the support layer 20 against the shell 30. In some embodiments, the support layer 20 may be removed from the pocket for replacement or, in other embodiments, the housing layer 10 may attach to the shell 30 so that the shell 30 fixes the support layer 20 within a closed pocket.

Embodiments include an inflatable foam pillow comprising a housing layer 10, a shell 30 and a support layer 20. The housing layer 10 may surround at least one side of the support layer 20. In some embodiments, the housing edge 70 of the housing layer 10 is bonded to the shell edge 50 of the shell 30 and thus secures the support layer 20 against the shell 30.

In some embodiments, the housing layer 10 may comprise a mesh material. In some embodiments, the housing layer 10 may comprise an unmeshed material. In some embodiments, the housing layer 10 may be made from a material selected from nylon, polyester, polypropylene woven, polypropylene non-woven, polyethylene, polyvinyl chloride (PVC), polytetrafluoroethylene (PTFE), cotton, vinyl, wool, flax, jute, silk, acrylic, spandex, aramid, olefin, hemp, rayon, lycra, linen or the like and combinations thereof.

In one embodiment, the support layer 20 may comprise polyurethane foam. In another embodiment, the support layer 20 may be viscoelastic polyurethane foam. In another embodiment, the support layer 20 may be memory foam. The support layer 20 may comprise conventional foam, high resilience foam, latex foam rubber, viscoelastic foam, polyurethane foam, memory foam, slow recovery foam, ground foam, shredded foam, rebond foam, latex foam, reflex foam, continuous foam, hyper-soft resilient foam, hyper-soft high airflow visco-elastic foam such as that disclosed in U.S. Patent Application No. 2005/0278852, the disclosure of which is hereby incorporated by reference, or any combinations thereof. In particular embodiments, the support layer 20 may be polyurethane foam created from a formulation comprising an isocyanate, a surfactant, and a polyol blend comprising a vegetable oil polyol as described in U.S. Pat. No. 7,700,661 (the “'661 patent”), the disclosure of which is hereby incorporated by reference. In further embodiments, the polyurethane foam may be made from a formulation comprising a polyol blend comprising a petrochemical polyol and a vegetable oil polyol, and an isocyanate blend comprising a 2,4 toluene diisocyanate (TDI) isomer and a 2,6 TDI isomer, wherein the ratio of petrochemical polyol to vegetable oil polyol in the polyol blend is about equal to the ratio of the 2,4 TDI isomer to the 2,6 TDI isomer in the isocyanate blend, as described in the '661 patent.

In other embodiments, the support layer may comprise feathers, down, fiber, polyester, gelatinous elastomer materials, gelatinous viscoelastomer, other cushioning media, including, without limitation, lubricated spherical objects, or the like.

In some embodiments, the support layer 20 may further contain additives such as, without limitation, activators, stabilizers, amines, colorants, dyes, pigments, chain-extending agents, surface-active agents (i.e., surfactants), fillers, and the like.

In some embodiments, the shell 30 may comprise a thermoplastic material. Suitable thermoplastic materials of embodiments include soft polyvinyl chloride, nylon, polypropylene, polyethylene, polytheylene vinyl acetate, fluoropolymers, urethane, copolymers of polyvinyl chloride and vinyl acetate, silicon rubber, and mixtures of polyvinyl chloride and synthetic rubber. The thermoplastic material may also be composed of a composite, such as a woven nylon material with a protective coating of urethane or vinyl. Suitable elastomers include poly(ethylene/butylene), hydrogenated poly(isoprene), hydrogenated poly(butadiene), hydrogenated poly(isoprene+butadiene), poly(ethylene/propylene), hydrogenated poly(ethylene/butylene+ethylene/propylene), polyurethane, polyisoprene, polybutadiene, or the like. In some embodiments, the shell 30 may be an inflatable bladder having two side walls that are bonded at a common edge. In some embodiments, the support layer is adjacent to one side wall of the inflatable bladder. In some embodiments, the shell 30 may be bonded to the housing layer 10 by heat sealing or radio frequency welding. In some embodiments, a shell edge 50 of the shell 30 may be bonded to a housing edge 70 of the housing layer 10 by heat sealing or radio frequency welding. In some embodiments, the shell 30 may be bonded to the housing layer 10 by heat sealing or radio frequency welding such that the inflatable portion of the shell 30 is not hindered.

In some embodiments, the pillow may further comprise a valve 40 or pump for inflating, maintaining air in and deflating the shell 30. In some embodiments, the valve 40 or pump may extend from a chamber within the shell 30 and through a side wall of the shell 30. The valve 40 may be any valve for inflating, maintaining air in and deflating a space such as, without limitation, a valve disclosed in U.S. Pat. No. 6,237,621; 6,508,624; 6,964,134; 6,755,208; or 6,986,360, the disclosure of each of which is hereby incorporated by reference.

In some embodiments, the shell 30 may be the outer walls of an inflatable bladder. In some embodiments, the inflatable bladder may be a single chamber bladder or a multi-chambered bladder. As used herein, a multi-chambered bladder means that the bladder may contain more than one enclosed space or chamber. In some embodiments, a chamber may be individually inflatable. In some embodiments, the multi-chambered bladder may comprise two or more chambers. In some embodiments, the multi-chambered bladder may comprise 2, 3, 4, 5, or 6 chambers. In some embodiments, the shell 30 may comprise a plastic. In some embodiments, the shell 30 may comprise an elastomer. In some embodiments, the shell 30 may be comprised of thermoplastic polyurethane, polyethylene, polystyrene, polyvinyl chloride (PVC), polytetrafluoroethylene (PTFE) or the like or combinations thereof.

In some embodiments, the pillow may be any shape, including but not limited to, oval, rectangular, circular, square, or the like. In some embodiments, the pillow may be shaped to provide better comfort for a body part. For example, in some embodiments, the pillow may be a U-shaped pillow or an L-shaped pillow. In some embodiments, the pillow may further comprise a pillow sleeve 60. In some embodiments, the pillow sleeve 60 may surround and contain some or all of the shell 30, the housing layer 10 and the support layer 20. In some embodiments, the pillow sleeve 60 may have an opening for the valve 40. In some embodiments, the sleeve 60 may be comprised of a fabric, a plastic, or combinations thereof, including, without limitation, nylon, polyester, polypropylene woven, polypropylene non-woven, polyethylene, polyvinyl chloride (PVC), polytetrafluoroethylene (PTFE), cotton, vinyl, wool, flax, jute, silk, acrylic, spandex, aramid, olefin, hemp, rayon, lycra, linen, polyethylene vinyl acetate, urethane, silicon rubber, rubber, latex, a mixture of polyvinyl chloride and synthetic rubber, or a copolymer of polyvinyl chloride and vinyl acetate.

Embodiments include a method of making an inflatable foam pillow comprising covering a support layer 20 with a housing layer 10, and attaching a shell 30 to the housing layer 10 so that the support layer 20 is secured between the housing layer 10 and the shell 30. In some embodiments, attaching may comprise attaching an edge 70 of the housing layer 10 and an edge 50 of the shell 30. In some embodiments, attaching may comprise adhering the housing layer 10 to the shell 30. In some embodiments, attaching may comprise sewing, gluing, adhesive sealing, ultrasonic welding, heat sealing, laser welding, radio frequency welding, stamping, chemical bonding or other suitable means. In some embodiments, attaching may comprise using a table press to apply pressure and heat seal or weld the material together. In some embodiments, attaching may comprise radio frequency welding. In some embodiments, radio frequency welding may comprise the use of high frequency electromagnetic waves. In some embodiments, the high frequency electromagnetic waves may have a frequency that is in a range from about 3 to about 50 MHz. In some embodiments, the high frequency electromagnetic waves may have a frequency that is in a range from about 3 to about 40 MHz. In some embodiments, the high frequency electromagnetic waves may have a frequency that is in a range from about 3 to about 30 MHz. In some embodiments, the high frequency electromagnetic waves may have a frequency that is in a range from about 5 to about 30 MHz. In some embodiments, the high frequency electromagnetic waves may have a frequency that is in a range from about 10 to about 30 MHz. In some embodiments, the high frequency electromagnetic waves may have a frequency that is in a range from about 15 to about 30 MHz. In some embodiments, the high frequency electromagnetic waves may have a frequency that is in a range from about 20 to about 30 MHz. In some embodiments, attaching may comprise heat sealing the housing layer and the shell. In some embodiments, attaching may comprise attaching the housing layer and the shell using a fastener. In some embodiments, the fastener may be buttons, zippers, clasps, loops, hooks, or a strip of hook material adapted to engage a loop pile material or a strip of loop material adapted to engage a hook material. In some embodiments, the fastener may be attached by sewing, gluing, heat sealing, laser welding, radio frequency welding, adhesive sealing, ultrasonic welding, stamping, chemical bonding or other suitable means. In some embodiments, covering may comprise adhering the support layer 20 to the housing layer 10. In some embodiments, the housing layer 10 may be a pouch encasing the support layer 20.

In an exemplary embodiment, the housing layer and the shell may be placed on a table press that applies pressure to both surface areas at the edges avoiding the inflatable portion of the housing layer. Dies may be used to direct the welding process. When the press comes together, high frequency electromagnetic waves (about 27.12 MHz) may be passed through the small area between the die and the table causing the material to weld together. Without wishing to be bound by theory, it is believed that this high frequency field may cause the molecules in certain materials to move and get hot, and the combination of this heat under pressure may cause the welded material to take the shape of the die.

Embodiments include a method of making an inflatable foam pillow comprising attaching edges 50 of a shell 30 to edges 70 of a housing layer 10 so that a support layer 20 is secured between the housing layer 10 and the shell 30. Embodiments include a method of making an inflatable foam pillow comprising covering a side of a support layer 20 with a housing layer 10, and attaching edges 50 of a shell 30 to edges 50 of the housing layer 10 so that the support layer 20 is secured between the housing layer 10 and the shell 30. In some embodiments, attaching may comprise attaching all edges of the housing layer with all edges the shell. In some embodiments, attaching may comprise attaching all edges except one of the housing layer to the shell. Embodiments include a method of making an inflatable foam pillow comprising covering a support layer 20 with a housing layer 10; and attaching the edges 50 of the shell 30 to edges 70 of the housing layer 10 so that the support layer is secured against a side wall of the shell 30.

Other embodiments include a method of making an inflatable foam pillow comprising placing a support layer 20 between a housing layer 10 and a shell 30; and bonding the shell 30 to the housing layer 10 of the pillow. In some embodiments, bonding comprises bonding an edge 70 of the housing layer 10 with an edge 50 of the shell 30. In some embodiments, bonding may comprise sewing, gluing, heat sealing, laser welding, adhesive sealing, ultrasonic, welding, stamping, chemical bonding or other suitable means. In some embodiments, bonding may comprise radio frequency sealing the housing layer 10 and the shell 30. In some embodiments, radio frequency sealing may comprise the use of high frequency electromagnetic waves. In some embodiments, the high frequency electromagnetic waves may have a frequency that is in a range from about 3 to about 50 MHz. In some embodiments, the high frequency electromagnetic waves may have a frequency that is in a range from about 3 to about 40 MHz. In some embodiments, the high frequency electromagnetic waves may have a frequency that is in a range from about 3 to about 30 MHz. In some embodiments, the high frequency electromagnetic waves may have a frequency that is in a range from about 5 to about 30 MHz. In some embodiments, the high frequency electromagnetic waves may have a frequency that is in a range from about 10 to about 30 MHz. In some embodiments, the high electromagnetic frequency waves may have a frequency that is in a range from about 15 to about 30 MHz. In some embodiments, the high frequency electromagnetic waves may have a frequency that is in a range from about 20 to about 30 MHz. In some embodiments, bonding may comprise heat sealing the housing layer 10 and the shell 30. In some embodiments, the heat sealing step may be done with a hot bar sealer, a continuous heat sealer, an impulse heat sealer, or a hot wire sealer.

In some embodiments, the housing layer 10 may be attached to an edge 50 of the shell 30 such that it avoids an inflatable area of the shell 30. In some embodiments, the housing layer 10 may be attached to the shell 30 within less than about 0.5 inches from an edge 50 of the shell 30. In some embodiments, the housing layer 10 may be attached to the shell 30 within less than about 0.25 inches from an edge 50 of the shell 30. In some embodiments, the housing layer 10 may be attached to the shell 30 within less than about 0.15 inches from an edge 50 of the shell 30. In some embodiments, the housing layer 10 may be attached to the shell 30 within less than about 0.125 inches from an edge 50 of the shell 30. In some embodiments, the housing layer 10 may be attached to the shell 30 within less than about 0.1 inches from an edge 50 of the shell 30.

Although the present invention has been described in considerable detail with reference to certain preferred embodiments thereof, other versions are possible. Therefore the spirit and scope of the invention should not be limited to the description and the preferred versions contained within this specification.

1. An inflatable pillow comprising:
a housing layer;
an inflatable shell that is attached to the housing layer; and
a support layer between the housing layer and the shell.

2. The pillow of claim 1, wherein the housing layer comprises a mesh material.

3. The pillow of claim 1, wherein the housing layer comprises a material selected from nylon, polyester, polypropylene woven, polypropylene non-woven, polyethylene, polyvinyl chloride, polytetrafluoroethylene, cotton, vinyl, hemp, rayon, lycra, linen, wool, flax, jute, silk, acrylic, spandex, aramid, olefin, or combinations thereof.

4. The pillow of claim 1, wherein the support layer comprises feathers, down, fiber, polyester, gelatinous elastomer, gelatinous viscoelastomer, lubricated spherical objects, conventional polyurethane foam, viscoelastic polyurethane foam, shredded foam, rebond foam, memory foam, latex rubber foam, high density polyurethane foam, lux foam, supreem foam, rebond foam, dry fast foam, closed cell foam, high resilience polyurethane foam, or a combination thereof.

5. The pillow of claim 1, wherein the support layer comprises conventional polyurethane foam, viscoelastic polyurethane foam, shredded foam, rebond foam, memory foam, latex rubber foam, high density polyurethane foam, lux foam, supreem foam, rebond foam, dry fast foam, closed cell foam, high resilience polyurethane foam, or a combination thereof.

6. The pillow of claim 1, wherein the shell comprises an inflatable bladder.

7. The pillow of claim 1, wherein the shell comprises a plastic.

8. The pillow of claim 1, wherein the shell comprises nylon, polyethylene vinyl acetate, rubber, latex, silicon rubber, urethane, fluoropolyemers, thermoplastic polyurethane, polyethylene, polypropylene, polystyrene, polyvinyl chloride, polytetrafluoroethylene or a combination thereof.

9. The pillow of claim 1 further comprising a valve for inflating the pillow, wherein the valve extends from a chamber within the shell and through a side wall of the shell.

10. The pillow of claim 1, wherein the shell is attached to the housing layer by an adhesive bond.

11. The pillow of claim 1, wherein the shell is attached to the housing layer by a heat seal.

12. The pillow of claim 1, wherein the shell is attached to the housing layer by a radio frequency weld that adheres an edge of the shell to an edge of the housing layer.

13. A method of making an inflatable foam pillow comprising:
covering a side of a support layer with a housing layer; and
attaching the housing layer to a shell so that the support layer is between the housing layer and the shell.

14. The method of claim 13, wherein attaching comprises adhering, sewing, gluing, heat sealing, laser welding, radio frequency welding, adhesive sealing, ultrasonic welding, stamping, chemical bonding or other suitable methods.

15. The method of claim 13, wherein attaching comprises heat sealing the housing layer and the shell.

16. The method of claim 15, wherein the heat sealing step is by using a hot bar sealer, a hot wire sealer, a continuous heat sealer, or an impulse heat sealer to seal together the housing layer and the shell.

17. The method of claim 13, wherein attaching comprises radio frequency welding the housing layer and the shell.

18. The method of claim 17, wherein radio frequency welding comprises using high frequency waves in a range from about 3 to about 30 MHz.

19. The method of claim 13, wherein attaching comprises bonding the housing layer and the shell using a fastener.

20. The method of claim 18, wherein the fastener is selected from buttons, zippers, clasps, loops, hooks, a strip of hook material adapted to engage a loop pile material or a strip of loop pile material adapted to engage a hook material.
